(19) United States
(12) Patent Application Publication
(10) Pub. No.: US 2008/0001037 A1
(43) Pub. Date: Jan. 3, 2008

(54) Actuator link assembly, flight control system and method of making same

(75) Inventors: Daniel Cox, Walterboro, SC (US); Darwin Eschenbacher, Freeland, MI (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/729,490

(22) Filed: Mar. 29, 2007

Related U.S. Application Data
(60) Provisional application No. 60/788,292, filed on Mar. 30, 2006.

(51) Int. Cl. G05G 1/00; B64C 13/28

(52) U.S. Cl. 244/221; 29/700; 74/469

(57) ABSTRACT

An actuator link assembly includes a sleeve member with a sleeve lug on one end. The sleeve lug is a split lug having primary and secondary lug portions. There is a coupling fixture on the sleeve member. There is a rod within the sleeve member with a rod lug between the primary and secondary sleeve lug portions. A locking member engages the rod and the sleeve member. A flight control system has a movable flight control element, a user control device and a linkage system between the control device and the flight control element. The linkage system includes an actuator that is controllable by a user. The system includes the actuator link assembly connected to the flight control element and to the actuator.

### CROSS-REFERENCE TO RELATED APPLICATION

This application claims the benefit of U.S. provisional application No. 60/788,292, filed Mar. 30, 2006, which is hereby incorporated herein by reference, in its entirety.

### FIELD OF THE INVENTION

This invention relates to flight control systems for aircraft, and in particular, to actuator linkages for such systems.

### BACKGROUND

A flight control system typically comprises control devices (e.g., cockpit controls such as a control stick, control column, control yoke, etc.), movable flight control elements, and a linkage system between the control devices and the flight control elements. The flight control elements (ailerons, elevators, stabilizers, spoilers, slats, rudder, etc.) provide the control surfaces of the wings and tail of an aircraft, and typically comprise slats and flaps on the leading and trailing edges of the wings and stabilizers, and sometimes include a hinged stabilizer. The linkage system between a user control and a flight control element in a flight control system includes an actuator link between an actuator controlled by the user (e.g., the pilot) and the flight control element. The actuator link imposes motion on the flight control element directly from the actuator. In a smaller plane, the actuator may be part of a mechanical linkage system connected to a cockpit control. In larger and/or more sophisticated aircraft, the actuator may be a hydraulic device, a servo mechanism, etc. Linkage systems comprise various types of operating mechanisms interconnecting the user controls with the flight control elements, depending on the size and design of the aircraft. Such systems may include mechanical systems, hydromechanical systems, electronic systems, etc.

Stabilizers and trailing and, leading edge flap systems are always considered flight-critical control systems because loss of control of the positioning of any of these flight control surfaces can lead to irrecoverable loss of flight control and probable loss of the aircraft. In order to assure reliability of control of these critical systems, duplicate (“redundant”) control lines, including redundant actuator links, can be provided. However, duplicate control lines add weight and complexity to the aircraft. In a prior art method for providing a duplicate actuator link, an outer structural housing was disposed around the primary actuator link shaft or rod. The outer housing method creates excessive weight as well as requires a large amount of space. The through-rod method poses issues of retentions of the rod end properly. There is an ongoing and long-standing need for a method of adding redundancy without significant added weight or complexity.

Based on the foregoing, it is the general object of this invention to provide an apparatus that improves upon prior art linkage systems.

### SUMMARY OF THE INVENTION

The present invention resides in one aspect in an actuator link assembly that comprises a sleeve member having a first sleeve end and a second sleeve end and a sleeve lug on the first sleeve end. The sleeve lug is a split lug comprising primary and secondary sleeve lug portions. There is a first coupling fixture on the sleeve member. There is also a support rod disposed within the sleeve member, the support rod having a first rod end and a second rod end, and a rod lug on the first rod end. The rod lug is disposed between the primary and secondary sleeve lug portions, and there is a locking member that engages the support rod and the sleeve member.

The present invention resides in another aspect in a flight control system that comprises a movable flight control element, a user control device and a linkage system between the user control device and the flight control element. The linkage system includes an actuator that is controllable by a user. The system includes an actuator link assembly as described herein connected to the flight control element and to the actuator.

In still another aspect, this invention provides a method of making an actuator link assembly that comprises providing a sleeve member having a hollow interior and a first sleeve end and a sleeve lug on the first sleeve end, the sleeve lug being a split lug comprising primary and secondary sleeve lug portions. A support rod having a first rod end, a second rod end, and a rod lug on the first rod end is also provided. The rod is inserted into the sleeve member and the rod lug is disposed between the primary and secondary sleeve lug portions. A coupling fixture is added onto the sleeve member, and a locking member is secured to the rod and to the sleeve member.

### BRIEF DESCRIPTION OF THE DRAWINGS

FIG. 1A is a schematic elevation view of an actuator link assembly according to one illustrative embodiment of the present invention;

FIG. 1B is a cross-sectional view of the actuator link assembly of FIG. 1 taken along line A-A;

FIG. 1C is a schematic perspective, partly exploded view of one end of an actuator link assembly according to one aspect of this invention;

FIG. 2 is a schematic perspective view of the end of the actuator link assembly of FIG. 1A;

FIG. 3 is a schematic perspective view of the end of the actuator link assembly of FIG. 1 with a linkage accessory therein; and

FIG. 4 is a schematic elevation view of an aircraft wing comprising a flight control system that includes the actuator link assembly of FIG. 1A in accordance with another aspect of this invention.

### DETAILED DESCRIPTION OF THE INVENTION

An actuator link assembly according to this invention provides redundant actuation function in moving a flight control element. In one embodiment, the actuator link assembly includes a sleeve member having first and second coupling fixtures thereon, and a support rod disposed within the sleeve member. One coupling fixture is configured to connect to a flight control element; the other coupling fixture is configured to connect to an actuator that moves the flight control element via the actuator link assembly. The first coupling fixture comprises a split lug on the sleeve member and a rod lug on the support rod. The split lug has primary and secondary sleeve lug portions. The split lug is configured to provide access to the hollow interior of the sleeve member. The rod lug is sized and configured to be disposed between the primary and secondary sleeve lug portions when the rod lug is seated in the sleeve lug.

A locking fixture secures the sleeve member to the rod at a point near their respective second ends.

In a particular embodiment, the second coupling fixture is situated between the locking fixture and the first coupling fixture.

In use, one coupling fixture is joined to a flight control element and the other coupling fixture is joined to an actuator so that the action of the actuator is transferred to the flight control element via the actuator link assembly. The sleeve member is the principal load bearing component of the actuator link assembly in transferring the actuator action. The rod lug and locking fixture are configured to keep the sleeve member intact and situated about the rod. In this way, should the sleeve member become severed or fractured, the motion of the actuator can be conveyed nonetheless from the actuator to the flight control element. By nesting the rod lug within the lug portions of the sleeve lug, redundancy of the actuation function is achieved without adding undue extra weight or cost to the linkage system. An actuator link assembly disclosed herein can be used in any kind of linkage system, and with any of the flight control elements of an aircraft, but most preferably is used on the stabilizer assemblies and the slats and flaps (the leading and trailing edge flaps).

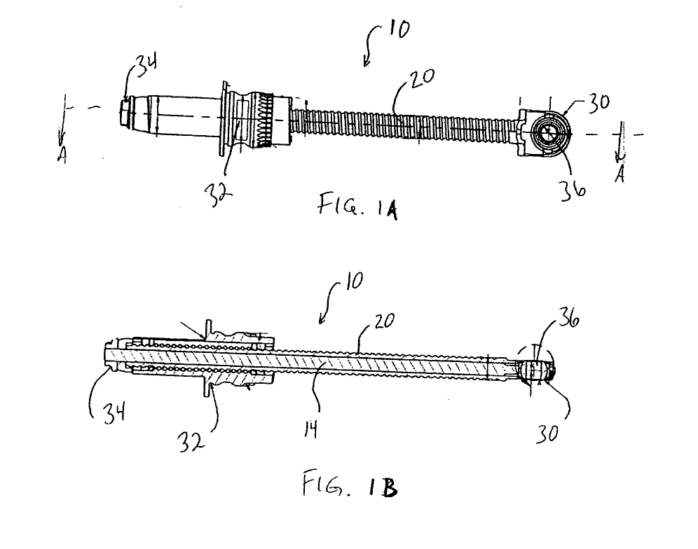

One embodiment of an actuator link assembly 10 according to this invention is shown in FIGS. 1A and 1B, which show that actuator link assembly 10 comprises a rod 14 disposed within the hollow interior bore of the sleeve member 20. A first coupling fixture 30 is disposed at one end of the sleeve member. Sleeve member 20 has a threaded exterior surface on which a second coupling fixture in the form of a threaded rotatable collar 32 is mounted.

A first end of actuator link assembly 10 is seen in FIG. 1C, with rod 14 withdrawn slightly from the interior of sleeve 20, to provide a view of the parts of the first coupling fixture. In the illustrated configuration, it can be seen that the first end of sleeve 20 is equipped with a first sleeve lug 24. First sleeve lug 24 is a split lug that comprises primary and secondary sleeve lug portions 24a, 24b. First sleeve lug 24 has an aperture 26s therethrough, the aperture 26s extending through both lug portions 24a, 24b. Lug portions 24a and 24b joined by a base portion 24c but are spaced apart from one another. Base portion 24c also provides an aperture through which rod 14 can be inserted into sleeve 20, between lug portions 24a and 24b.

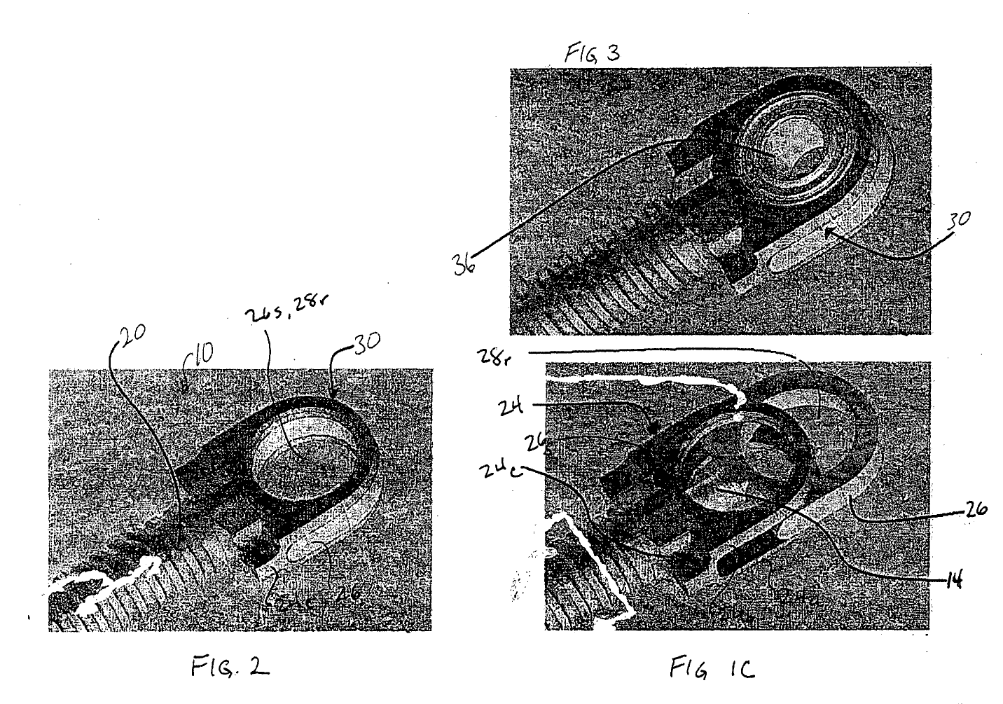

It can also be seen in FIG. 1C that the support rod 14 comprises a rod lug 28 on the end of rod 14. Rod lug 28 has an aperture 28r therein and rod lug 28 is configured to slide between lug portions 24a and 24b. Rod lug 28 and sleeve lug 24 are configured to that when rod 14 is fully inserted in sleeve 20, as seen in FIG. 2, base portion 24c serves as a stop for rod lug 28, and the aperture 28r is aligned with the aperture 26s. In such a configuration, rod lug 28 and sleeve lug 24 together constitute a coupling component 30 on the first end of the actuator link assembly 10.

The second end of rod 14 (opposite the rod lug) is disposed near the second end of the sleeve 20 when rod 14 is fully inserted into the sleeve. As seen in FIGS. 1A and 1B, a locking fixture 34 is provided to engage the second end of the rod and the second end of the sleeve member. In one embodiment, the second end of the rod is threaded and the locking fixture comprises a lock nut that is threaded onto the end of the rod. The lock nut is sized to prevent the sleeve member from sliding off the rod. In addition, the lock fixture 34 may serve as a stop for coupling fixture 30. In an alternative embodiment, the sleeve locking fixture is integral with the second end of the sleeve member (opposite from the split lug). For example, the sleeve member may include an interior screw thread at the opening of the sleeve member. The rod may then comprise a corresponding screw thread sized to engage the internal thread on the sleeve member.

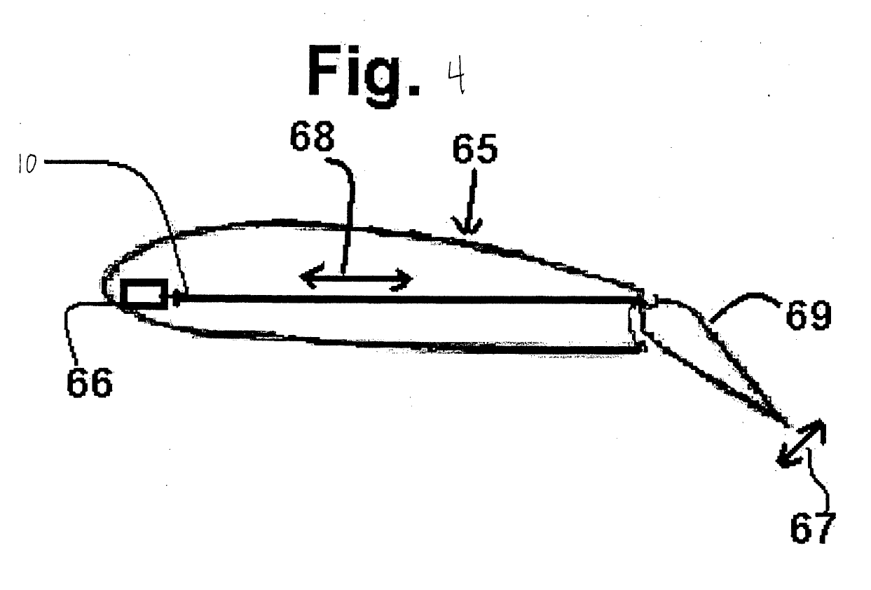

Optionally, a linkage accessory may be added to a coupling fixture on actuator link assembly 10 to facilitate the engagement of the actuator link assembly 10 with the actuator and/or with the flight control element. For example, the linkage accessory may be mounted on the first coupling fixture 30 and may engage both the sleeve lug 24 and the rod lug 28. For example, FIG. 3 shows a linkage accessory comprising an annular bushing 36 that may be mounted in the aligned apertures 26s, 28r of the sleeve lug 24 and the rod lug 28. In one specific embodiment, bushing 36 comprises a spherical plain bearing. The sleeve member 20 and split lug can be machined as a unitary component from a single billet, or may be fabricated from separate pieces, as long as the structural integrity can be maintained at the junction between the sleeve member 20 and the lug 10 under adverse loading conditions. Similarly, the rod lug 26 and the rod 14 are optimally formed from a single billet of material that is machined to appropriate dimension and tolerance. Optionally, the billet from which the rod 14 will be formed is cast in rod form to minimize the need to remove much material from that portion of the billet. Such billets are made from suitable materials metals such as aluminum, titanium, steel, low carbon steel or stainless steel. The selection of material is governed by the nature of the application and service conditions as are well known in the industry.

To assemble the actuator link assembly, the rod is inserted into the sleeve member so that the rod lug is between the primary and secondary sleeve lug portions, a coupling fixture is mounted on the sleeve member (e.g., a threaded collar may be screwed onto the outer threaded surface of the sleeve member) and a locking fixture is mounted at the second ends of the sleeve member and the rod. An optional linkage accessory may be mounted in the lugs.

FIG. 4 provides a schematic illustration of one use of an actuator link assembly as described herein. This figure shows a wing 65 of an aircraft. The wing 65 is equipped with a movable flap 69 that is attached to the stationary part of the wing by a hinge mechanism. An actuator 66 is mounted on the wing 65 and is controlled by the pilot. The actuator link assembly 10 has a first coupling fixture, i.e., collar 32, coupled to the actuator 66 and a second coupling fixture 30 connected to the flap 69. In use, the pilot operates a control device that controls the actuator. When the actuator 66 rotates the collar 32, the sleeve 20 of the actuator link assembly 10 translates the motion to the flap 69 as indicated by arrow 68. In turn, the flap 69 moves as suggested by the arrow 67. In the event of failure or damage to the sleeve member of the actuator link assembly, the rod and the locking fixture will keep the fractured parts of the sleeve member in place and the rod will assume the full burden of controlling the flight control element

The length of the actuator link assembly 10 is governed by the flight control system in which it is employed. In common situations, the length of the actuator link assembly 10 may vary from a few inches to six feet. In certain aircraft configurations, the actuator link assembly 10 can be nearly ten feet long.

The terms “first,” “second,” and the like herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. An actuator link assembly comprising:
a sleeve member having a first sleeve end and a second sleeve end, a sleeve lug on the first sleeve end, the sleeve lug being a split lug comprising primary and secondary sleeve lug portions, and a first coupling fixture on the sleeve member;
a support rod disposed within the sleeve member, the support rod having a first rod end and a second rod end, a rod lug on the first rod end;
wherein the rod lug is disposed between the primary and secondary sleeve lug portions; and
a locking member that engages the support rod and the sleeve member.

2. The assembly of claim 1, wherein the first coupling fixture is situated between the locking fixture and the sleeve lug.

3. The assembly of claim 1, wherein the sleeve lug and the rod lug together comprise a second coupling fixture, the assembly further comprising a linkage accessory engaged with the second coupling fixture.

4. The assembly of claim 1, wherein the sleeve lug comprises a sleeve lug aperture and the rod lug comprises a rod lug aperture; and
wherein the sleeve lug aperture is aligned with the rod lug aperture.

5. The assembly of claim 4, wherein the sleeve lug and the rod lug together comprise a second coupling fixture, the assembly further comprising a linkage accessory engaged with the second coupling fixture.

6. The assembly of claim 5, wherein the linkage accessory comprises a first bushing.

7. In a flight control system comprising a movable flight control element, a user control device and a linkage system between the user control device and the flight control element, the linkage system including an actuator that is controllable by a user, the improvement comprising an actuator link assembly as defined in claim 1 connected to the flight control element and to the actuator.

8. The flight control system of claim 7, wherein the actuator link assembly comprises a linkage accessory engaged with the sleeve lug, with the rod lug and with the flight control element.

9. The flight control system of claim 7, wherein first coupling fixture is situated between the locking fixture and the sleeve lug.

10. The flight control system of claim 7, wherein the sleeve lug and the rod lug together comprise a second coupling fixture, the assembly further comprising a linkage accessory engaged with the second coupling fixture.

11. The flight control system of claim 7, wherein the sleeve lug comprises a sleeve lug aperture and the rod lug comprises a rod lug aperture; and
wherein the sleeve lug aperture is aligned with the rod lug aperture.

12. The flight control system of claim 11, wherein the sleeve lug and the rod lug together comprise a second coupling fixture, the assembly further comprising a linkage accessory engaged with the second coupling fixture.

13. The assembly of claim 12, wherein the linkage accessory comprises a first bushing.

14. A method of making an actuator link assembly, comprising:
providing a sleeve member having a hollow interior and a first sleeve end and a sleeve lug on the first sleeve end, the sleeve lug being a split lug comprising primary and secondary sleeve lug portions;
providing a support rod having a first rod end, a second rod end, and a rod lug on the first rod end;
inserting the rod into the sleeve member and disposing the rod lug between the primary and secondary sleeve lug portions;
adding a coupling fixture onto the sleeve member; and
securing a locking member to the rod and to the sleeve member.
